(19) United States
(12) Patent Application Publication
(10) Pub. No.: US 2019/0125620 A1
(43) Pub. Date: May 2, 2019

(54) THERAPY BALLS AND METHOD OF USE

(71) Applicant: Ping Feng, Spring, TX (US)

(72) Inventor: Ping Feng, Spring, TX (US)

(21) Appl. No.: 16/174,829

(22) Filed: Oct. 30, 2018

Related U.S. Application Data
(60) Provisional application No. 62/578,755, filed on Oct. 30, 2017.

(51) Int. Cl. A61H 15/00

(52) U.S. Cl. CPC A61H 15/00; A61H 2015/005; A61H 2201/0119; A61H 2201/0192; A61H 2205/081; A61H 2203/0406; A61H 2203/0431; A61H 2201/0157; A61H 2201/169

(57) ABSTRACT

A therapy system includes an elastic cord extending from a first end to a second end; a first fastener secured to the first end; a second fastener secured to the second end, the second fastener is configured to secure to the first fastener; a first elastic ball having a first channel extending through a first thickness of the first elastic ball; and a second elastic ball having a second channel extending through a second thickness of the second elastic ball.

### BACKGROUND

### 1. Field of the Invention

The present invention relates generally to a system that provides easy access to massage the back of a human body, and more specifically, to a device having one or more adjustable balls adapted to come into contact with the back of the user to apply pressure thereagainst.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1-6 are various views of a system and method of use in accordance to a preferred embodiment of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

Referring now to the drawings wherein like reference characters identify corresponding or similar elements throughout the several views, FIGS. 1-6 depict various views of a system 101 and method of use in accordance with a preferred embodiment of the present application.

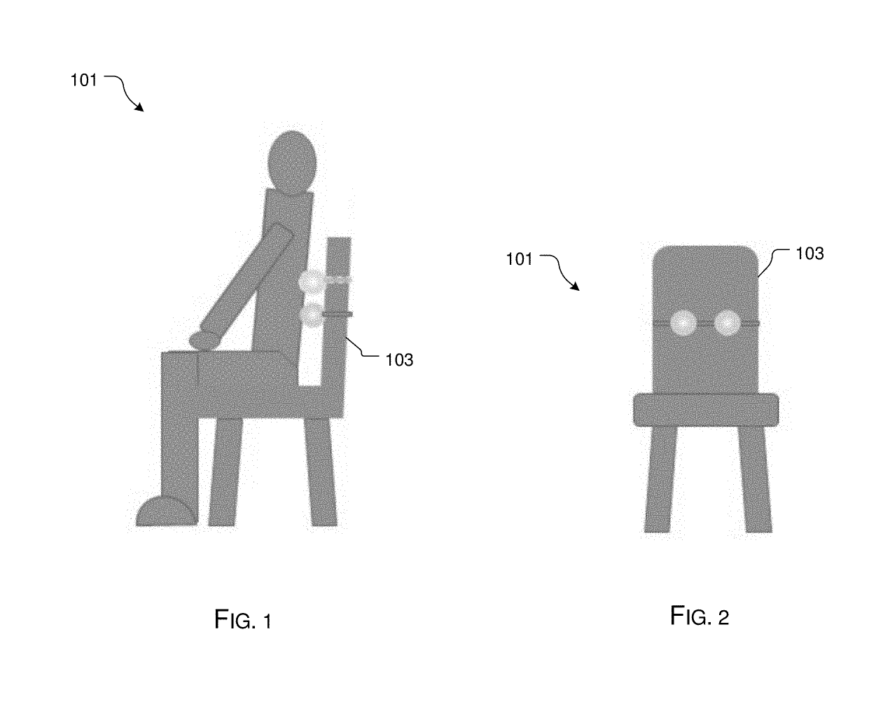

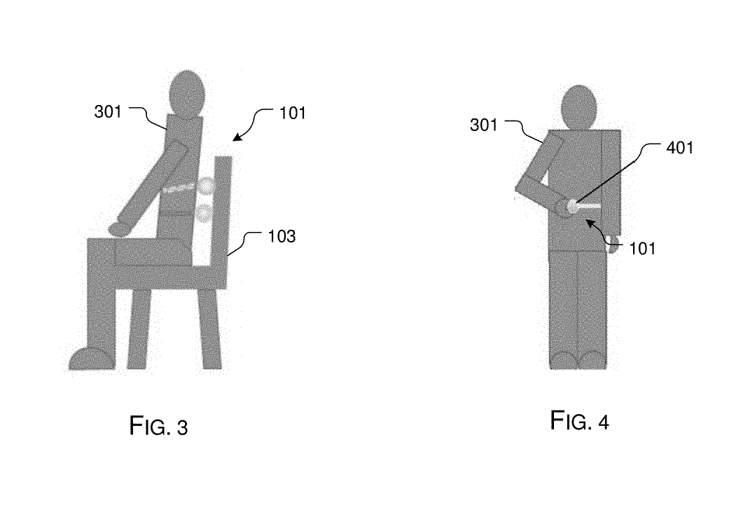

Referring now to FIGS. 1 and 2 in the drawings, respective side and front views of the system 101 are shown attached to a chair 103. In FIG. 1, it can be shown that the strap is adjustable to secured at different heights along the chair. This feature enables the balls to come into contact with different locations on the back of the user. It is also contemplated having the system 101 secured directly to the user 301 via the strap, as shown in FIGS. 3 and 4.

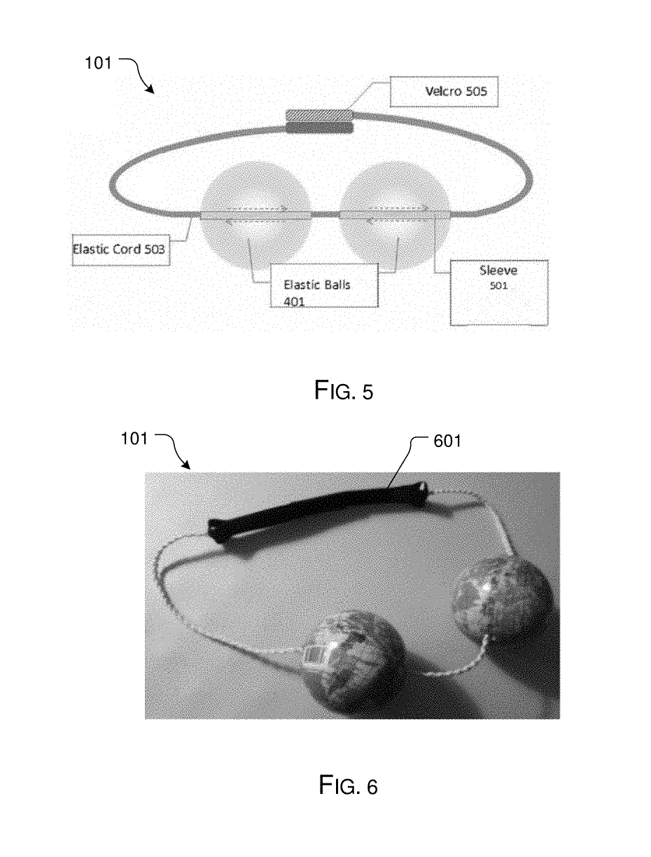

Further detail features of the system 101 are shown in FIGS. 5 and 6. The system 101 includes one or more balls 401 adjustably secured to an elastic cord 503. The balls 401 have a sleeve 501 disposed within the thickness of the balls 401 and a VELCRO and/or similar quick-release devices 505 are utilized to secures the two elastic cords 503 together. A shown in FIG. 6, it is also contemplated utilizing a member 601 configured to secure to the two cords, and that the cords are formed of a non-elastic material. Also, it is shown that an image can be placed on the outer surface of the balls 401.

Some of unique features believed characteristic of the present invention are: the device enables easy access to massage on the back of human body, either in a fixed setting (in office, etc.) or a mobile setting (on flight, in car, etc.); the body massage pieces are connected via and movable along a cord/belt that can be wrapped to (and unwrapped from) an fixed object (e.g. back of chair) or to human body. Massage then can be accomplished by using human body to press the massage pieces against back of chair, or any available rigid object; in a mobile setting, the device also allows for hand squeezing exercise when massage piece(s) is positioned in front of the body; and no electrical or any other type of power supply is needed

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A therapy system, comprising:
an elastic cord extending from a first end to a second end;
a first fastener secured to the first end;
a second fastener secured to the second end, the second fastener is configured to secure to the first fastener;
a first elastic ball having a first channel extending through a first thickness of the first elastic ball; and
a second elastic ball having a second channel extending through a second thickness of the second elastic ball;
wherein the elastic cord extends through both the first channel and the second channel; and
wherein the first elastic ball is adjustable in distance from the second elastic ball along the elastic cord.
